(19) United States
(12) Patent Application Publication
(10) Pub. No.: US 2014/0002071 A1
(43) Pub. Date: Jan. 2, 2014

(54) PROBE FOR ANALYZING AN ASSEMBLY OF RODS OR TUBES

(71) Applicant: Jean-Pierre Martin, Garches (FR)

(72) Inventor: Jean-Pierre Martin, Garches (FR)

(73) Assignees: GEO ENERGY, Garches (FR); Gordon MOWAT, Anahuac, TX (US)

(21) Appl. No.: 13/978,457

(22) PCT Filed: Jan. 5, 2012
(86) PCT No.: PCT/FR2012/050034

§ 371 Date: Sep. 17, 2013

(30) Foreign Application Priority Data
Jan. 7, 2011 (FR) 1150119

(51) Int. Cl. G01N 27/82

(52) U.S. Cl. CPC G01N 27/82
USPC 324/240

(57) ABSTRACT

The invention relates to a probe for analysing an assembly of rods including an elongate housing (1) supporting at a first end a permanent magnet (5), the north-south axis of which is parallel to the axis of the rods and, in a position sufficiently separated from said magnet, a set of magnetometers (7) for detecting axial, radial and tangential components of the magnetisation of the rods.

### FIELD OF THE INVENTION

The present disclosure relates to devices and methods for analyzing the state of hollow drilling rods and of pipes or tubings especially used in oil and gas exploration and production (hereafter, it will simply be spoken of “rods”).

While a pipe string is being inserted in the ground, or once this drill pipe string or a tubing has been installed, various measurements are desired to be performed on this pipe string or this tubing. For example, it is desired to know whether a rod is stuck by a deep caving, this caving being likely to be several thousands of meters away from the starting point of the drilling. It can also be desired to detect the position of the joints of the pipe string or of the tubing. Indeed, a drill pipe string or a tubing is formed of an assembly of rods or of pipes, for example having lengths on the order of some ten meters which are screwed to one another, and the counting of joints provides a position location. It may also be desired to locate perforations or weak areas, especially due to corrosion, in the tubings. It may also be desired to know the stress state at a point of a pipe string while it is being lifted from the initial point, for example, to create a neutral point at a given depth.

### DISCUSSION OF PRIOR ART

Currently, to perform these various measurements, probes analyzing magnetic effects induced in the rods are especially used. These probes comprise means for measuring the magnetic field, possibly associated with magnetic field creation means.

The means for measuring the magnetic field generally are means for measuring the magnetic field which only operate if the probe is moving, the amplitude of the collected signals being closely dependent on the displacement speed.

The means for creating a magnetic field in a rod or a pipe (which is generally made of a ferromagnetic material or another material capable of acquiring a remanent magnetization under the effect of a field) generally are means for generating an A.C. or pulsed field. It has especially been provided to use coils or rotating magnets as field creation means. Such means are used either to obtain a periodic remanent magnetization in the rod or the pipe, or more generally to create local magnetization areas by periodically applying pulses to a coil while it is moving in the pipe string or the tubing.

All the means currently used are relatively complex and expensive, especially due to the fact that, when a coil is desired to be excited at a great depth inside of a pipe string, this coil should be powered with a relatively high current by long conductors, and that, further, the bottom of a well may be at a high temperature, capable of ranging up to values greater than 175° C., which considerably limits the power capable of being dissipated in the coil.

Another difficulty is that the analysis probe sent into a pipe string is generally associated with other elements, especially comprising explosives intended to help unscrewing a rod joint at a selected location, or to perforate a tubing for the subsequent bringing in of an oil well. The detonators associated with such explosives may be affected by parasites resulting from the application of intense current pulses in their immediate vicinity. Efficient shieldings should then be provided, which increases the cost of the device and complicates its forming.

A solution to these various problems has been provided in French patent application 07/53921 of Mar. 20, 2007 which provides a probe for analyzing a string of rods or pipes comprising an elongated housing supporting at a first end at least one first magnetometer and at a position sufficiently distant from the magnetometer a permanent magnet having its north-south axis perpendicular to the axis of the rods.

This solution implies for the magnetization provided to the rods to have no symmetry of revolution. It thus provides good results when what is to be detected does not depend on the direction of the magnet in a plane perpendicular to the pipe, for example, to detect a sticking, pipe joints, or a neutral point. However, it does not enable to distinguish a disturbance having a symmetry of revolution such as mentioned hereabove of a defect such as a perforation or a weak area, especially due to corrosion, located in a specific radial area. It thus does not enable to finely analyze such a defect.

Further, if several successive passages are desired to be performed, the magnet will not be directed in the same way from one passage to the other, which risks affecting the measurements.

### SUMMARY OF THE INVENTION

Thus, an object of the present invention is to provide a particularly simple probe for analyzing an assembly of drilling rods or of pipes or tubings capable of detecting, not only specificities or defects with a symmetry of revolution, but also specificities or defects having no symmetry of revolution, such as perforations or weak areas, especially due to corrosion, located in a specific radial area, and to finely analyze such defects.

Another object of the present invention is to provide several possible applications, possibly simultaneous, of this probe, especially for:
detecting the positions of perforations and/or of weak areas, for example, due to corrosion, of a pipe, and analyzing such defects,
detecting the location of a rod sticking point,
detecting the positions of rod or pipe joints,
detecting a neutral point for the stress applied to a pipe string.

To achieve all or part of these and other objects, the present invention provides a probe for analyzing a rod assembly comprising an elongated housing supporting at a first end a permanent magnet having its north-south axis parallel to the axis of the rods and having a length greater than the internal diameter of the rods, and, at a position sufficiently distant from this magnet, an assembly of magnetometers for detecting the axial, radial, and tangential components of the rod magnetization.

According to an embodiment of the present invention, the magnet is formed of an assembly of magnets.

According to an embodiment of the present invention, the magnetometers are magnetoresistance magnetometers.

The present invention also provides an analysis method using a probe such as hereabove, comprising a step of magnetizing the rods by passage of the probe, and a step of reading the intensity of the axial and radial magnetization components to detect an anomaly having or not a symmetry of revolution.

According to an embodiment of the present invention, when an anomaly having no symmetry of revolution is detected, the shape and the dimensions of the corresponding defect is determined by processing the axial, radial, and tangential magnetization components.

### BRIEF DESCRIPTION OF THE DRAWINGS

The foregoing and other features and advantages of the present invention will be discussed in detail in the following non-limiting description of specific embodiments in connection with the accompanying drawings, among which:

FIG. 1 is a cross-section view schematically illustrating a rod having a probe according to an embodiment of the present invention arranged therein; and

FIG. 2 is an enlarged view of a portion of a rod submitted to a magnetic field according to an embodiment of the present invention.

### DETAILED DESCRIPTION

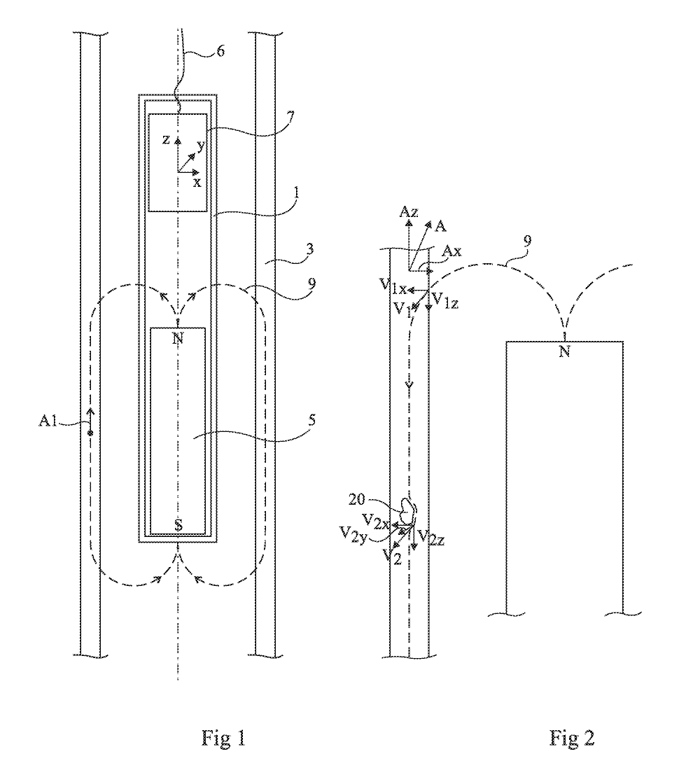

As illustrated in FIG. 1, a probe housing 1 is sized to be able to be displaced inside of a pipe string 3 by being connected to a pulling cable 6, also intended for transmitting electric signals.

As previously explained, probe housing 1 usually comprises various elements other than the analysis elements which will be described hereafter, for example, specific drive means, rod wall separation means, means for starting an explosion, signal processing and transmission means, etc.

Magnetic analysis probe housing 1 supports a magnet 5 having its north-south axis parallel to the axis of rods 3. This housing also supports an assembly of magnetic field measurement devices 7 and of electronic processing circuits. Magnetic field measurement devices 7 are magnetometers, that is, elements capable of measuring the field created by a remanent magnetization, independently from any movement of the probe, for example, Hall-effect sensors or magnetoresistance sensors. A configuration such that the direct influence of magnet 5 on the measurement devices is negligible should of course be provided. As an example, the axial distance between the magnet and each magnetometer assembly may approximately range from 30 cm to 2 meters.

The probe according to the present invention may be used in various ways according to what is desired to be measured. Generally, it will be started by taking down the probe to continuously magnetize the rod walls, and the magnetization induced in the rods will be detected as the probe moves downwards or in a subsequent pulling back up of the probe. In this last case, various intermediate operations of application of stress to the pipe string may have been carried out as described in detail in above-mentioned French patent application 07/53921.

The magnetometers are arranged to detect the axial, radial, and tangential components of the magnetization and to detect the radial position of a defect. Thus, at least one axial component detection magnetometer and an assembly of radial and tangential component detection magnetometers arranged at the periphery of the probe will be used. Magnetometers, each of which is capable of measuring from 1 to 3 field components, for example, Honeywell magnetometers available under reference HMC 1022 which provide indications along two orthogonal axes may be used. The radial and tangential component detection magnetometers arranged at the probe periphery will be by a sufficient number to provide a desired angular determination accuracy. In the case where the number of magnetometers is significant, such magnetometers may be arranged on several transverse planes to take into account the bulk of the devices. Such magnetometers will for example be arranged in a helix. The z shifting of the provided results will then be taken into account by a processing software.

As illustrated in FIG. 1, the field generated by magnet 5 induces a magnetic field in rods 3, substantially according to the direction indicated by arrows 9, so that an essentially axial magnetization designated by vector A1 is generated at each point of the rods.

FIG. 2 is a partial enlarged cross-section view of a portion of FIG. 2 to better illustrate the path followed by magnetic field lines 9 and their effect on the pipe.

The field lines penetrate obliquely into the rods according to a vector V1 which has two components, an axial component V1z and a radial component V1x.

Thus, once the magnet has vertically displaced along a pipe portion, there remains a magnetization A which comprises an axial component Az and a lower radial component Ax. If the pipe is even along its entire periphery at the considered location, this same magnetization A can be found all around the pipe periphery.

When the magnetic field lines come across a defect in the pipe, for example, a gap 20 for example created by corrosion, the field lines are deviated and field vector V2 will thus have components V2z, V2x, and V2y, which results in an area where the magnetization vector will have radial, tangential, and axial components A2x, A2y, and A2z (not shown).

During the passage of the analysis portion of the probe, the magnetometers distributed around the device periphery will detect the existence of these radial and tangential components, unevenly distributed along the pipe periphery. The presence of a defect can thus be detected and various analytic processing means will enable to quantify the shape and the size of this defect.

Thus, the probe according to the present invention enables to detect unevennesses having a symmetry of revolution, for example corresponding to rod joints, and to make them out from local defects for example corresponding to corrosion or to piercings.

The detection mode of a local defect has more specifically been described herein. To detect the location of a rod sticking, to count joints or to help unscrewing a drill pipe string at a given depth, the probe may be used in the same way as described in above-mentioned French patent application 07/53921. The detection is then essentially based on the indications given by an axial component detection magnetometer, while radial and tangential component detection magnetometers provide identical indications (symmetry of revolution).

An advantage of the axial assembly of magnet 5 is the fact that this magnet may have and will preferably have a length much greater than the diameter of the rods to be analyzed selected according to the intensity of the magnetization which is desired to be imposed in the pipe walls. This magnet may be formed of a stack of elementary magnets. The magnets will for example be samarium-cobalt or neodymium-iron-boron magnets capable of creating a magnetic induction of high value.

Another advantage of the axial assembly of magnet 5 is the repeatability of the obtained measurements. This aspect is very important since tubing corrosion measurements are performed at regular intervals in the lifetime of a well to monitor the progress of this corrosion to be able to possibly take action at the right moment to correct the situation. With an axial magnet, the magnetization always is in the same direction, whatever the rotation direction of the probe with respect to the well and, further, it is homogeneously reinforced at each passage of the magnet, which reinforces the measured signals.

It should further be noted that, with an axial magnet such as described herein, a same probe may be used for rods of quite different diameters, for example, drilling rods having a diameter ranging from 8.75 to 12.5 cm (from 3.5 to 5 inches), tubings accessed through a pipe for bringing up oil or gas, the tubing for example having a diameter of 17.5 cm (7 inches) while the pipe for bringing up oil or gas only has a diameter ranging from 5 to 6.1 cm (from 2 inches to 2 inches ⅜^{th}) Indeed, it is will be sufficient for the axial magnet to have a length at least equal to the largest possible diameter, that is, 17.5 cm or 7 inches in the case of the above example.

These specific advantages of the present invention result from the simple association of a fixed high-power permanent magnet with a detector of magnetometer type. The use with a fixed magnet of flow-variation measurement sensors instead of magnetization sensors would not provide the same results since the measurements could then only be performed during a displacement of the probe.

The present invention is likely to have various alterations and modifications which will occur to those skilled in the art. In particular, a system such as described in the above-mentioned patent, where detectors are arranged on either side of the magnet, may be adopted.

1. A probe for analyzing a rod assembly comprising an elongated housing supporting at a first end a permanent magnet having its north-south axis parallel to the axis of the rods and having a length greater than the internal diameter of the rods, and, at a position sufficiently distant from this magnet, an assembly of magnetometers for detecting the axial, radial, and tangential components of the rod magnetization.

2. The probe of claim 1, wherein said magnet is formed of an assembly of magnets.

3. The probe of claim 1, wherein the magnetometers are magnetoresistance magnetometers.

4. An analysis method using the probe of claim 1, comprising:
a step of magnetizing the rods by passage of the probe, and
a step of reading the intensity of the axial and radial magnetization components to detect an anomaly having or not a symmetry of revolution.

5. The analysis method of claim 4, wherein, when an anomaly having no symmetry of revolution is detected, the shape and the dimensions of the corresponding defect are determined by processing the axial, radial, and tangential magnetization components.

6. The method of claim 4, wherein said magnet is formed of an assembly of magnets.

7. The method of claim 4, wherein the magnetometers are magnetoresistance magnetometers.
